(19) United States
(12) Patent Application Publication
(10) Pub. No.: US 2022/0282793 A1
(43) Pub. Date: Sep. 8, 2022

(54) VALVE DEVICE FOR A PACKAGING MACHINE

(71) Applicant: MULTIVAC SEPP HAGGENMUELLER SE & CO. KG, Wolfertschwenden (DE)

(72) Inventors: Albert GABLER, Lachen-Albishofen (DE); Markus KROPF, Kempten (DE)

(73) Assignee: MULTIVAC SEPP HAGGENMUELLER SE & CO. KG, Wolfertschwenden (DE)

(21) Appl. No.: 17/686,454

(22) Filed: Mar. 4, 2022

(30) Foreign Application Priority Data
Mar. 4, 2021 (DE) 102021105175.4

(51) Int. Cl. F16K 1/12; F16K 51/02; F16K 1/36; B65B 51/10

(52) U.S. Cl. CPC F16K 1/126; F16K 51/02; F16K 1/36; B65B 51/10

(57) ABSTRACT

A valve device may include a valve body, a flow channel penetrating the valve body, and a sealing member arranged in the flow channel, where the flow channel, starting out from the sealing member, comprises an outflow section defining an axial direction. The sealing member is adjustable parallel to the axial direction between a closed position sealing the flow channel and an open position opening at least in part the flow channel. The outflow section of the flow channel comprises an at least substantially cylindrical partial section, and the sealing member comprises a cylinder section having an at least substantially cylindrical shape and being configured to project into the cylindrical partial section of the outflow section in the closed position of the sealing member. A method for regulating a pressure in a packaging machine by way of such a valve device is also disclosed.

### CROSS-REFERENCE TO RELATED APPLICATIONS

This application claims foreign priority benefits under 35 U.S.C. § 119(a)-(d) to German patent application number DE 10 2021 105 175.4, filed Mar. 4, 2021, which is incorporated by reference in its entirety.

### TECHNICAL FIELD

The disclosure relates to a valve device according to the preamble of claim 1, in particular for use in a packaging machine, as well as to a method for regulating a pressure in a packaging machine.

### BACKGROUND

A conventional valve device is disclosed in DE 10 2008 039 200 A1. Its sealing member can be moved substantially orthogonally to a flow channel penetrating the valve body. The sealing member has a wedge-shaped head, while a sealing surface of the valve body forms an acute angle with the adjustment path of the sealing member. The drawback of the conventional vacuum valve is that the sealing member can suddenly “tear away” from the valve body during operation and corresponding sudden pressure changes can arise. The vacuum valve of DE 10 2008 039 200 A1 is intended in particular for use in deep-drawing packaging machines.

A packaging machine with a pressure regulating device is disclosed DE 10 2018 100 224 A1. This pressure regulating device comprises two 2/2-way valves for setting an evacuation and/or gas flushing pressure in the packaging machine.

### SUMMARY

An object of the present disclosure is to improve a valve device and a method for regulating a pressure in a packaging machine in terms of the precision of a pressure regulation. This object is satisfied by a valve device according to the disclosure and by a method according to the disclosure.

Unlike the device of DE 10 2008 039 200 A1, the sealing member of the disclosure is not adjustable vertically but parallel to the axial direction of the outflow section of the flow channel. The “outflow section” denotes that part of the flow channel which, starting out from the sealing member, leads to a vacuum source. In addition, the sealing member of the disclosure has a cylinder section having an at least substantially cylindrical shape and being configured to project into the cylindrical partial section of the outflow section in the closed position of the sealing member. In the context of the disclosure (including the method), the axial direction can also be defined by a comparatively short section of the outflow section, in particular by its cylindrical partial section.

Together, these measures lead to the opening behavior of the valve device being changed considerably. The valve device according to the disclosure allows for the cylinder section of the sealing member to further remain guided at least temporarily in the cylindrical partial section of the outflow section, albeit with play or subject to the formation of a gap between the sealing member and the outflow section which allows for a limited flow of fluid while the valve device begins opening the valve. In other words: at the moment at which the valve body, starting from the sealing closed position, is released from a sealing seat, the cylinder section of the sealing member continues to be guided in the outflow section. Despite the negative pressure present in the outflow section, this limited fluid flow prevents the sealing member, when being released from the closed position, from suddenly breaking out as soon as a flow can flow along the sealing member on at least one side of the sealing member. The prevention of the sudden detachment of the sealing member in turn prevents sudden changes in the pressure profile and therefore allows for gentler, considerably more precise control of the pressure as compared to conventional valve devices.

The outflow section of the flow channel preferably comprises a conical sealing section and the sealing member in turn comprises a conical section which is configured to abut against the conical sealing section of the flow channel in the closed position of the sealing member. A particularly tight seal can be ensured in this way.

In an advantageous variant, the sealing member has a control contour at a distal end. The “distal end” means that end which faces away from a bearing area of the sealing member. A control contour is characterized in that it enables an at least largely uniform change in the opening width of the flow channel at least over a certain range of motion of the sealing member. This further enhances the precision in adjusting a specific pressure value and/or a smooth transition between two different pressure values.

The control contour can be disposed between the cylinder section of the sealing member and a vertex of the sealing member. It can be the region of the sealing member where it projects the furthest into the outflow section of the flow channel.

It has been found to be particularly effective to have the control contour converge from the cylinder section to a vertex of the sealing member. A conical or, alternatively, a rounded control contour is conceivable. Rounded control contours include those with a cross section that is semicircular, a segment of a circle, or parabolic, or also a cross section corresponding to a Gothic pointed arch or concave shapes.

The sealing member is preferably pretensioned into its closed position in order to cause the flow channel to close in a non-energized state, in particular for safety reasons.

A spring can expediently be provided for preloading and preload the sealing member into its closed position.

In particular in connection to pre-loading the sealing member, a single-action actuator, preferably a pneumatic actuator, can be sufficient and provided for moving the sealing member into its open position. This simplifies the configuration as compared to a double-action actuator.

The valve device according to the disclosure can be used particularly advantageously in a packaging machine, in particular a deep-drawing packaging machine, a chamber machine, a chamber belt machine, or a tray sealer. For example, the evacuation and/or the gas flushing of an interior of a chamber in the packaging machine can be controlled by way of the valve device.

The disclosure also relates to a method for regulating a pressure in a packaging machine by way of a valve device, where the valve device comprises a valve body, a flow channel penetrating the valve body, and a sealing member arranged in the flow channel, where the flow channel, starting out from the sealing member, comprises an outflow section defining an axial direction. The method is characterized in that the sealing member is adjusted from a closed position of the sealing member in the axial direction, where a cylinder section of the sealing member having an at least substantially cylindrical shape is guided in a cylindrical part of the outflow section, possibly with play or subject to the formation of a gap, see above. In particular, this guiding can take place while the sealing member detaches from a sealing seat, with the advantages explained above.

The cylinder section of the sealing member is preferably guided in the cylindrical partial section of the outflow section, while a conical section of the sealing member, which in the closed position of the sealing member abuts against a conical sealing section of the flow channel, detaches from the sealing section of the flow channel. Guiding the sealing member prevents the occurrence of a sudden lateral displacement or tilting of the sealing member with correspondingly violent sudden pressure changes.

A vacuum source is preferably in fluid connection to the outflow section such that it generates a negative pressure in the outflow section of the flow channel. This enhances a securely sealing seat of the sealing member in its closed position, while the configuration according to the disclosure of the sealing member and the valve body enables the valve device to open in a precise and impact-free manner.

In a further development of the disclosure, the sealing member can be moved gradually or stepwise between its closed position and an open position. The smaller the steps, the more precise the pressure control.

A gradual or step-wise motion of the sealing member between its closed position and an open position can preferably be achieved by supplying defined amounts of fluid in a stepwise and/or clocked manner from a fluid source into a piston chamber of an actuator for adjusting the sealing member.

### BRIEF DESCRIPTION OF THE DRAWINGS

In the following, an advantageous embodiment of the disclosure shall further be illustrated with reference to drawings, where in detail:

FIG. 1 shows a schematic perspective view of a packaging machine;

FIG. 2 shows a top view onto a valve device according to the disclosure in a closed position;

FIG. 3 shows a side view of the valve device in the closed position;

FIGS. 4 and 5 show different states during a transition from the closed position to an open position;

FIG. 6 shows the valve device in its open position; and

FIG. 7 shows a second embodiment of a sealing member.

Same components are provided with the same reference characters throughout the figures.

### DETAILED DESCRIPTION

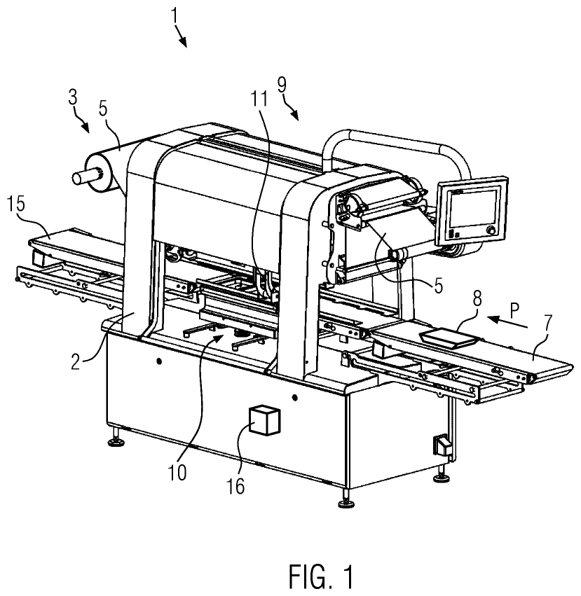

FIG. 1 shows an embodiment of a packaging machine 1 which can be a tray sealer, like in the present example. It can comprise a frame 2. Packaging machine 1 can furthermore comprise a feed belt 7; it can additionally comprise a sealing station 9. Trays 8 that are filled but at this point in time not yet closed can be transported to sealing station 9 by use of feed belt 7. The trays can optionally be relocated into sealing station 9 in a production direction P by way of a gripper device 11 and closed there with a top film 5 supplied from above, for example, by sealing top film 5 onto trays 8. For this purpose, sealing station 9 can comprise a sealing tool 9. The sealed and therefore finished packagings can be relocated from sealing station 9 to a discharge belt 15 via gripper device 11.

After sealing top film 5 thereonto, regions of top film 5 corresponding to the packagings or packaging assemblies can be cut out from the web of top film 5 in sealing station 9. What remains is a film lattice of top film 5 which is wound by a device 3 for winding film 5.

Alternatively, a packaging machine 1 can be configured as a deep-drawing packaging machine, a chamber machine, or a chamber belt machine.

Packaging machine 1 comprises a vacuum source 16 with which a vacuum or negative pressure is generated in a chamber 18 of sealing station 9 before top film 5 is sealed onto trays 8. In addition, a gas-flushing device (not shown) can be provided.

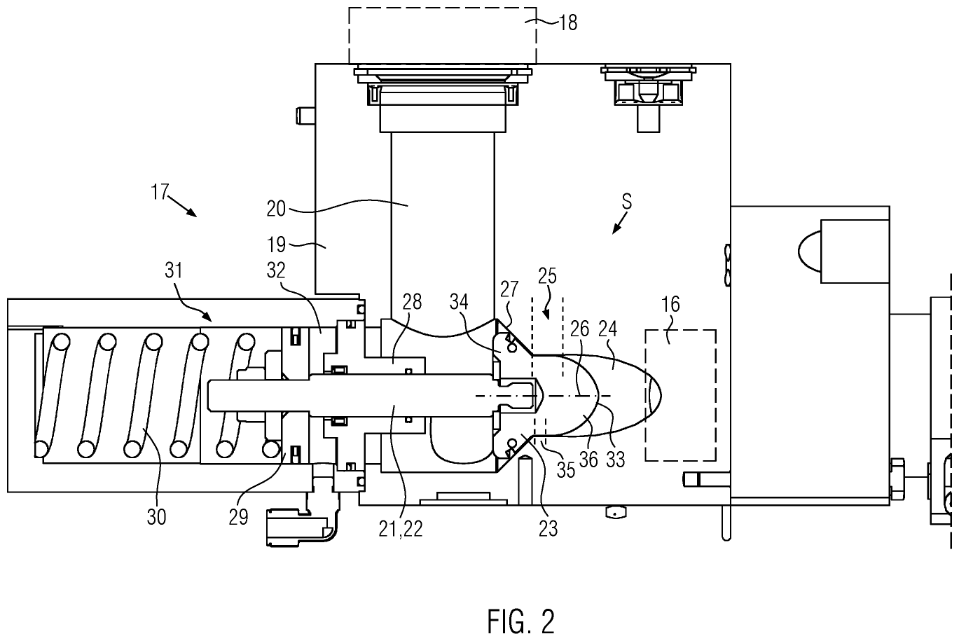

FIG. 2 shows the top view onto a valve device 17 according to the disclosure which is functionally arranged between (schematically indicated) chamber 18 of sealing station 9 and vacuum source 16. Valve device 17 comprises a valve body 19 which is penetrated by a flow channel 20. Flow channel 20 therefore represents a fluid connection between vacuum source 16 and chamber 18 when valve device 17 is in an open position.

A sealing member 21 is received in valve body 19. Sealing member 21 comprises a tappet 22 and a head 23 firmly connected, for example screwed, to tappet 22.

A section of flow channel 20 disposed between sealing member 21 of valve device 17 and vacuum source 16 is referred to as “outflow section 24”. This is for the reason that the fluid (for example air) extracted from chamber 18 flows out via this outflow section 24, starting from sealing member 21, in the direction toward vacuum source 16.

Outflow section 24 of flow channel 20 has a cylindrical partial section 25. In this cylindrical partial section 25, outflow section 24 has a uniform, preferably circular cross section and defines an axial direction 26 of outflow section 24. Axial direction 26 is independent of the (possibly curved) profile with which outflow section 24 extends beyond cylindrical partial section 25 in the direction toward vacuum source 16. A conical sealing section 27 of flow channel 20 is disposed on the side of flow channel 20 facing away from vacuum source 16.

Tappet 22 of sealing member 21 is guided and supported in a bearing 28, for example, in a central region of tappet 22. A piston plate 29 is connected to tappet 22 or formed integrally therewith. A spring 30, presently a helical spring 30, engages with piston plate 29 and preloads sealing member 21 to its closed position S, which is assumed in FIG. 2.

A single-action actuator 31 in the present example is used to move sealing member 21 out of its closed position S against the force of spring 30. For this purpose, actuator 31 comprises a piston chamber 32 which is arranged between bearing 28 and piston plate 29. If piston chamber 32 is filled with a pressurized fluid, for example, compressed air, then piston plate 29 and tappet 22 connected thereto move to the left in a direction opposite to the force of spring 30. An adjustment direction of sealing member 21 is parallel to axial direction 26 of outflow section 24. Instead of a single-action actuator 31 and a spring 30, a double-action actuator can also be used.

Head 23 of sealing member 21 is disposed at a distal end 33 of sealing member 21 which projects into outflow channel 24 in closed position S and is connected to tappet 22 As shown in the present embodiment, head 23 can have substantially three different sections. A conical section 34 of head 23 is complementary in its shape and dimensions to conical sealing section 27 of flow channel 20. Closed position S of sealing member 21 is characterized in that conical section 34 of sealing member 21 abuts against conical sealing section 27 in a sealing manner. The preload exerted by spring 30 presses conical section 34 against conical sealing section 27.

Head 23 furthermore comprises a cylinder section 35. Cylinder section 35 has a cross section which corresponds substantially to that of cylindrical partial section 25 of outflow section 24 and is possibly minimally smaller (e.g., in the range of 1 to 5 tenths of a millimeter) than the inner diameter of cylindrical partial section 25. Cylinder section 35 can have a length of, for example, 2 to 12 mm.

A control contour 36 is disposed adjacent to cylinder section 35 at distal end 33 of head 23. Control contour 36 is characterized by a width that gradually decreases towards distal end 33. In the embodiment illustrated, control contour 33 has a rounded, roughly parabolic or semicircular, convex contour. Control contour 33 converges to a vertex 39.

Head 23 of sealing member 21 in the present embodiment is formed integrally, for example, from metal, such as stainless steel. However, a multi-part formation would also be conceivable. In order to obtain an increased sealing effect, the surfaces of conical section 34 and/or of sealing section 27 could be provided with elastic material such as a coating, for example, comprising rubber or silicone.

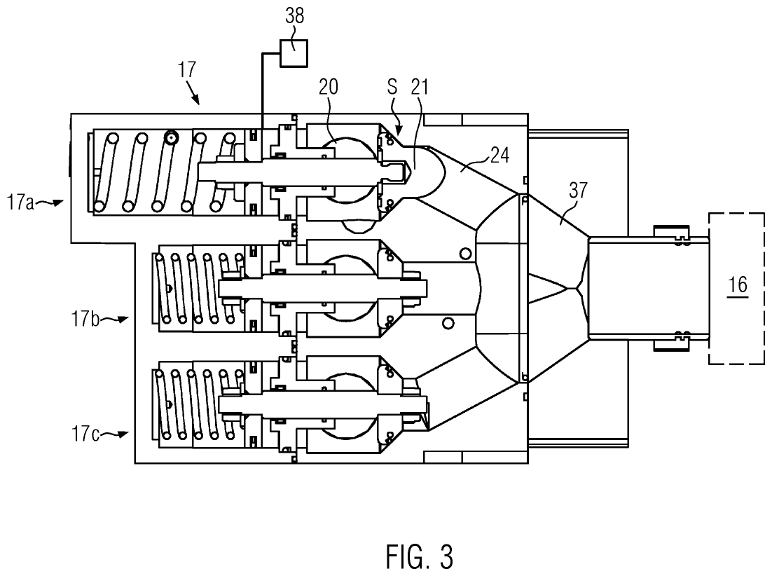

FIG. 3 shows a side view of valve device 17. It can be seen that valve device 17 comprises three valves 17a, 17b, 17c arranged one above the other, of which only the uppermost one 17a is equipped with a cylinder section 35 of sealing member 21 in the manner according to the disclosure. However, it would also be conceivable to configure valve device 17 with only a single valve, with two valves, or with more than three valves, and to configure any number of the individual valves present in the manner according to the disclosure.

In the embodiment according to FIG. 3, outflow channels 24 of all three individual valves 17a, 17b, 17c are united by a manifold 37 and led to vacuum source 16. A fluid source 38 (for example a valve) for supplying piston chamber 32 of actuator 31 with pressurized fluid is also shown schematically. In FIG. 3, all three valves 17a, 17b, 17c are in their closed position S.

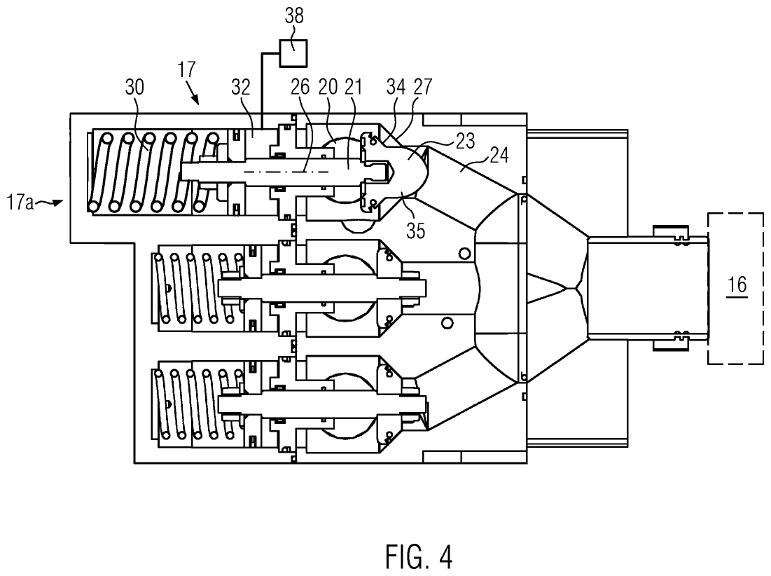

FIGS. 4 to 6 show different states of valve device 17 when moving sealing member 21 out of closed position S. Only one respective motion of first valve 17a of valve device 17 is presently observed.

In FIG. 4, fluid under pressure has been introduced from fluid source 38 into piston chamber 32 of actuator 31. The pressure in chamber 32 exceeds the force of spring 30 so that piston plate 29 together with entire sealing member 21 are adjusted to the left parallel to axial direction 26.

The negative pressure generated in closed position S (see FIG. 3) by vacuum source 16 is applied to distal end 33 of sealing member 21 and generates a force acting upon sealing member 21 in the same magnitude as the force of spring 30. The adjustment shown in FIG. 4 of sealing member 21 to the left causes conical section 34 of sealing member 21 to detach from sealing section 27 of flow channel 20. This creates a fluid flow along head 23 of sealing member 21 through flow channel 20. In the situation shown in FIG. 4, sealing member 21 has moved from closed position S by, for example, 2 to 6 mm to the left. During this adjustment path, cylinder section 35 of head 23 remains guided in cylindrical partial section 25 of outflow section 24. This circumstance prevents sealing member 21 from breaking out laterally or tilting around bearing 28 when sealing member 21 leaves closed position S and a fluid flow forms along head 23.

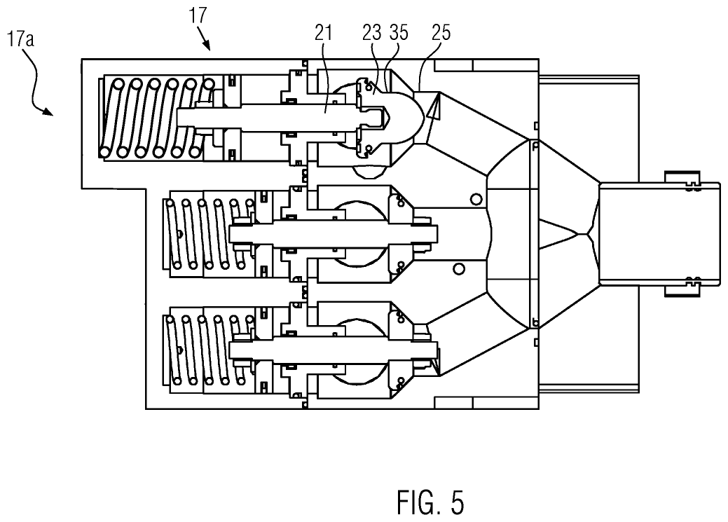

FIG. 5 shows a situation in which, starting out from FIG. 2, sealing member 21 has moved even further to the left. Cylinder section 35 of sealing member 21 is now no longer guided in the cylindrical partial section of outflow section 24.

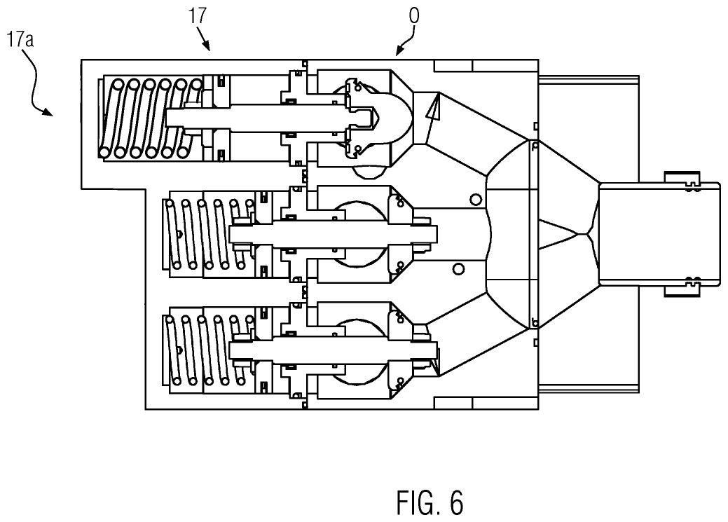

FIG. 6 shows valve 17a of valve device 17 in its fully open position O. The cross section of flow channel 20 is now open to the maximum.

During operation, valve device 17 can be moved stepwise or continuously between closed position S and open position O. Stepwise adjustment can take place by way of a clocked supply of defined quantities of fluid from fluid source 38. It is also possible to control valve device 17 in such a way that selective intermediate positions are assumed between closed position S and open position O, for example, the intermediate positions shown in FIG. 4 or 5.

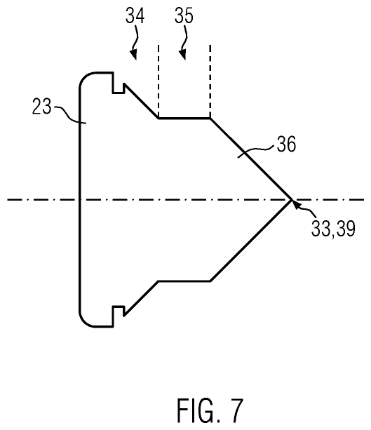

FIG. 7 shows a second embodiment of a head 23 of a sealing member 21. Unlike the first embodiment, control contour 36 is there formed to be conical; it converges towards a point or vertex 39 at distal end 33 of head 23.

Based on the embodiments illustrated, valve device 17 and the method can be modified in many ways. Some of the possible variants have already been indicated above. It is possible, for example, for control contour 36 to have concave instead of convex or conical outer surfaces. In the context of the disclosure, “cylindrical” or “cylinder section” are also to be understood to mean shapes with deviations of up to approx. 5° from a pure cylinder shape.

What is claimed is:

1. A valve device comprising:
a valve body;
a flow channel penetrating the valve body; and
a sealing member arranged in the flow channel;
wherein the flow channel, starting out from the sealing member, comprises an outflow section defining an axial direction, the sealing member is adjustable parallel to the axial direction between a closed position sealing the flow channel and an open position opening at least in part the flow channel, the outflow section of the flow channel comprises an at least substantially cylindrical partial section, and the sealing member comprises a cylinder section having an at least substantially cylindrical shape and being configured to project into the at least substantially cylindrical partial section of the outflow section in the closed position of the sealing member.

2. The valve device according to claim 1, wherein the outflow section of the flow channel comprises a conical sealing section, and the sealing member comprises a conical section which is configured to abut against the conical sealing section of the flow channel in the closed position of the sealing member.

3. The valve device according to claim 1, wherein the sealing member has a control contour at a distal end.

4. The valve device according to claim 3, wherein the control contour is disposed between the cylinder section and a vertex of the sealing member.

5. The valve device according to claim 3, wherein the control contour converges from the cylinder section to a vertex of the sealing member.

6. The valve device according to claim 1, wherein the sealing member has a conical or rounded control contour.

7. The valve device according to claim 1, wherein the sealing member is preloaded toward the closed position.

8. The valve device according to claim 7, wherein a spring is provided for preloading the sealing member toward the closed position.

9. The valve device according to claim 1, further comprising a single-action actuator for moving the sealing member to the open position.

10. The valve device according to claim 9, wherein the single-action actuator comprises a pneumatic actuator.

11. A packaging machine comprising the valve device according to claim 1.

12. A method for regulating a pressure in a packaging machine by way of a valve device, wherein the valve device includes a valve body, a flow channel penetrating the valve body, and a sealing member arranged in the flow channel, wherein the flow channel, starting out from the sealing member, includes an outflow section defining an axial direction, the method comprising:
adjusting the sealing member in the axial direction from a closed position of the sealing member, wherein during the adjusting a cylinder section of the sealing member having an at least substantially cylindrical shape is guided in a cylindrical partial section of the outflow section.

13. The method according to claim 12, wherein a conical section of the sealing member, which abuts against a conical sealing section of the flow channel in the closed position of the sealing member, is detached from the sealing section of the flow channel while the cylinder section of the sealing member is guided in the cylindrical partial section of the outflow section.

14. The method according to claim 13, wherein a vacuum source in fluid connection to the outflow section generates a negative pressure in the outflow section.

15. The method according to claim 12, wherein a vacuum source in fluid connection to the outflow section generates a negative pressure in the outflow section.

16. The method according to claim 12, wherein the sealing member is moved gradually or stepwise between its closed position and an open position.

17. The method according to claim 12, wherein starting out from the closed position of the sealing member, the cylinder section of the sealing member is guided via a motion path of the sealing member of at least 2 mm in the cylindrical partial section of the outflow section.

18. The method according to claim 12, wherein starting out from the closed position of the sealing member, the cylinder section of the sealing member is guided via a motion path of the sealing member of at least 5 mm in the cylindrical partial section of the outflow section.
